(19) United States
(12) Patent Application Publication
(10) Pub. No.: US 2008/0197007 A1
(43) Pub. Date: Aug. 21, 2008

(54) Key switch for shortening distance

(75) Inventor: Chin-Hung Lin, Taipei County (TW)

Correspondence Address: Reed Smith LLP;ATTN: Juan Carlos A. Marquez, Suite 1400, 3110 Fairview Park Drive, Falls Church, VA, 22042, US

(73) Assignee: Darfon Electronics Corporation

(21) Appl. No.: 12/071,129

(22) Filed: Feb. 15, 2008

(30) Foreign Application Priority Data
Feb. 16, 2007 (TW) 96203262

(51) Int. Cl. H01H 13/70

(52) U.S. Cl. 200/344

(57) ABSTRACT

A key switch includes a base, a cap, an up-down mechanism and a blocker. The cap is disposed on the base. The up-down mechanism id disposed between the base and the cap and defines a maximum distance to allow the cap to move vertically relative to the base. The blocker is configured to block the cap when the cap moves vertically relative to the base with a traveling distance. The traveling distance is shorter than the maximum distance.

### CROSS REFERENCE TO RELATED APPLICATIONS

This application claims the right of priority based on Taiwan Patent Application No. 96203262, entitled “Key switch for shortening distance”, filed on Feb. 16, 2007, which is incorporated herein by reference and assigned to the assignee herein.

### FIELD OF THE INVENTION

The present invention relates to a key switch, and more particularly, to a key switch for reducing distance.

### BACKGROUND OF THE INVENTION

A keyboard is widely used in various apparatus or equipments, for example, for connecting with computer to input texts or numerals. Conventional key switches are manufactured to have a uniform height or stroke distance in order to reduce costs and simplify design. However, different uses require further design considerations. Some key switches, such as the two key switches on the touchpad of a notebook computer, require different distances (i.e. stroke distances) when used. Key switches are also used when using a touchpad, and if the distance of the two key switches on the touchpad is too large, the time for a user to fully press the key switches will increase, thereby affecting the operation smoothness.

Therefore, it is necessary to modify key switches under different frameworks to provide a key switch with reduced stroke distance.

### SUMMARY OF THE INVENTION

According to an aspect of the present invention, there is provided a key switch for reducing distance to shorten the amount of time spent by a user in pressing the key switch, thereby improving the operation smoothness.

In an embodiment of the present invention, the key switch includes a base, a cap, an up-down mechanism, and a blocker. The cap is disposed over the base and the up-down mechanism, defining a maximum distance to allow the cap to move vertically with respect to the base, is disposed between the base and the cap. The blocker is provided so that the cap, blocked by the blocker while moving with respect to the base, travels a distance shorter than the maximum distance defined by the up-down mechanism.

### BRIEF DESCRIPTION OF THE DRAWINGS

FIG. 1. is a top view of an embodiment of the present invention;

FIG. 2. is a side view of a first embodiment of the present invention;

FIG. 3. is a side view of the key switch after traveling a distance according to an embodiment of the present invention; and

FIG. 4. is a side view of a second embodiment of the present invention.

### DETAILED DESCRIPTION OF THE INVENTION

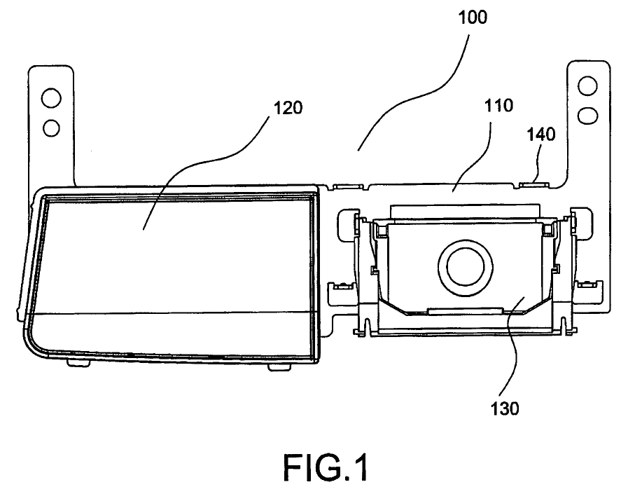

A key switch with reduced stroke distance is disclosed in the present invention. Reference can be made to FIG. 1 to 4 of the drawings in conjunction with the following description in order to make the expression of the present invention more clear and thorough.

FIG. 1 is a top view of a first embodiment of the present invention, wherein a key switch 100 with a cap is shown on the left and a key switch 100 without the cap is shown on the right. That is, in the exemplary embodiment of the present invention, the key switch 100 includes a base 110, a cap 120, an up-down mechanism 130, and a blocker 140. The cap 120 is disposed over the base, whereas the up-down mechanism 130 is disposed between the base 110 and the cap 120 to allow the cap 120 to move vertically with respect to the base 110. The blocker 140 is provided so that the cap 120 can be blocked while moving with respect to the base 110.

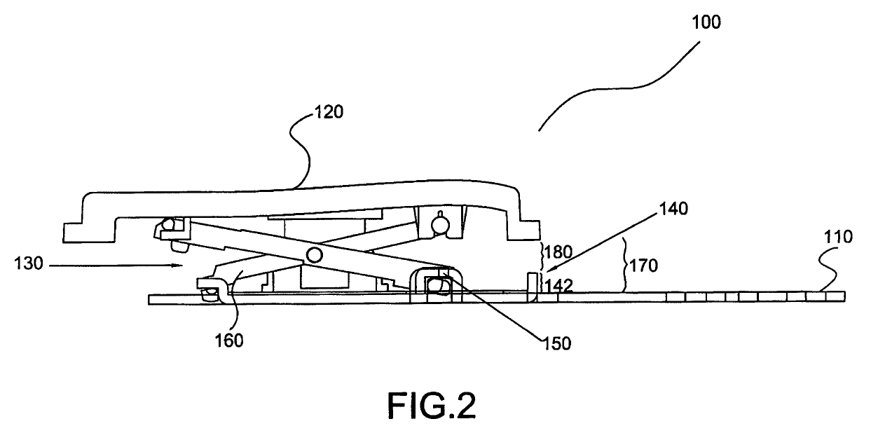

FIG. 2 is a side view of the key switch 100 as shown in FIG. 1. As shown in FIG. 2, a maximum distance 170 between the cap 120 and the base 110 is defined as the largest distance that the cap 120 may travel with respect to the base 110. The maximum distance 170 is determined by the up-down mechanism 130 disposed between the base 110 and the cap 120. That is, the maximum distance 170 is the largest distance that the cap 120 supported by the up-down mechanism 130 may move toward the base 110 without being blocked by any blocker. In the present invention, the blocker 140 is provided protruding from the base 110 so as to reduce the distance that the cap 120 may travel. That is, the blocker 140 is provided to reduce the distance the cap 120 may travel when pressed by the user. The blocker 140 has a protruding length 142, which can be designed in accordance with a desired traveling distance of the cap 120, as well as a desired distance reduced by the blocker 140. When moving toward the base 110, the cap 120 gets in contact with the blocker 140 before reaching the maximum distance 170, so that the cap 120 travels an operation distance 180 shorter than the maximum distance 170 due to the blocking effect of the blocker 140, thereby reducing the distance and the time that the cap 120 actually travels when pressed by the user.

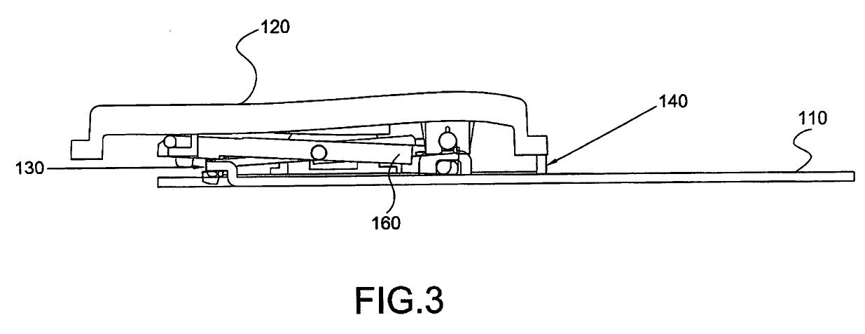

FIG. 3 is a schematic diagram of the cap 120 after traveling a distance. As shown in FIG. 3, while the cap 120 moves with respect to the base 110, the cap 120 gets in contact with the blocker 140 and the movement is stopped by the blocker 140. The actual distance that the cap 120 travels is the operation distance 180 in FIG. 2. In this embodiment, the blocker 140 and the base 110 may be formed integrally or separately. For example, the blocker 140 may be integrally formed as an upward bending part extending from the base 110. Alternatively, the blocker 140 and the base 110 may be separately formed and attached to each other by any suitable techniques, such as by adhesives.

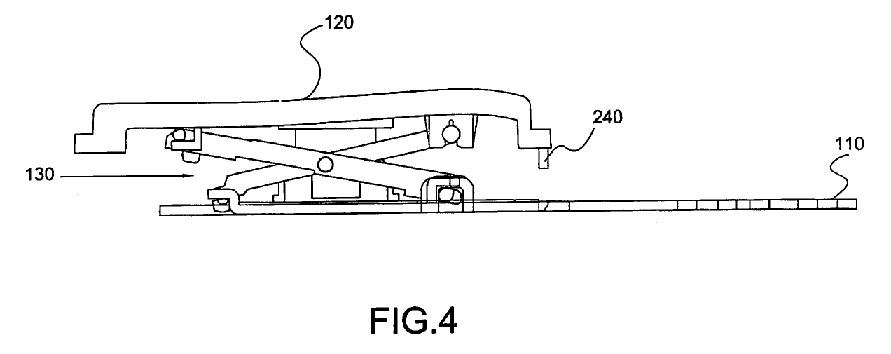

FIG. 4 is a second embodiment of the present invention, which shows the blocker 240 provided on a location different from FIG. 1. In this embodiment, the blocker 240 may be provided on the cap 120, such as the bottom of the cap 120, to achieve the effect of distance reduction as well. A maximum distance 170 is defined between the cap 120 and the base 110 as the largest traveling distance of the cap 120 with respect to the base 110. The maximum distance 170 is determined by the up-down mechanism 130 disposed between the base 110 and the cap 120. The blocker 240 is provided to protrude from the cap 110 in order to reduce the traveling distance of the cap 120. The blocker 240 has a protruding length 142, which determines a desired distance that the cap 120 travels and a desired distance to be reduced. While the cap 120 moves toward the base 110 before reaching the maximum distance 170, the blocker 240 first gets in contact with the base 110 before reaching the maximum distance 170 so that the cap 120 travels an operation distance 180 shorter than the maximum distance 170 due to the blocking effect of the blocker 240, thereby reducing the distance and the time that the cap 120 actually travels when pressed by the user.

In this embodiment, the schematic diagram of the cap 120 after traveling a distance is similar to FIG. 3. While the cap moves with respect to the base 110, the movement of the cap 120 is stopped because the blocker 240 gets in contact with the base 110. The actual distance that the cap 120 travels is then the operation distance 180 as shown in FIG. 2. In addition, the blocker 240 and the cap 120 may also be formed integrally or separately. For example, the blocker 240 may be integrally formed as a protrusion part extending from the bottom of the cap 120. Alternatively, the blocker 240 and the cap 120 may be separately formed and attached to each other by any suitable techniques, such as by adhesives.

Referring back to FIG. 2, in yet another embodiment, the key switch 100 includes a bearing part 150 for supporting a support arm 160 of the up-down mechanism 130. Because the blocker 140 or 240 is provided, when assembling the cap 120 with the up-down mechanism 130, the cap 120 may be hindered by the blocker 140 or 240, hence increasing the difficulty of connecting the hook (not shown) on the cap 120 to the support arm 160 of the up-down mechanism 130. Therefore, when assembling the cap 120 with the up-down mechanism 130, the support arm 160 may be lifted due to the existence of the bearing part 150 so as to improve the feasibility of connecting the hook (not shown) of the cap 120 to hole (not shown) on the support arm 160. As such, the cap 120 can be easily assembled with the up-down mechanism 130. Furthermore, the bearing part 150 and the base 110 may be integrally connected as a single piece.

The detailed description of the above preferred embodiments is to describe the technical features and spirit of the present invention, and the disclosed preferred embodiments are not intended to limit the scope of the present invention. On the contrary, the preferred embodiments and their variations or equivalents all fall within the scope of the present invention. Therefore, the scope of the claims should be accorded to by the broadest interpretation so as to encompass all such modifications and equivalent arrangements.

What is claimed is:

1. A key switch, comprising
a base;
a cap disposed over the base;
an up-down mechanism installed between the base and the cap, defining a maximum distance so as to allow the cap to move vertically with respect to the base; and
a blocker;
wherein the blocker is provided so that the cap, blocked by the blocker while moving with respect to the base, travels a distance shorter than the maximum distance.

2. The key switch of claim 1, wherein the blocker is provided to protrude upward from the base.

3. The key switch of claim 2, wherein the blocker and the base are connected integrally.

4. The key switch of claim 2, wherein the blocker is characterized by a length substantially equal to the maximum distance subtracted by the distance.

5. The key switch of claim 2, wherein the cap is opposed by the blocker when the cap moves with respect to the base before reaching the maximum distance.

6. The key switch of claim 1, wherein the blocker is provided on the cap such that the blocker is in contact with the base when the cap moves with respect to the base before reaching the maximum distance.

7. The key switch of claim 1, further comprising a bearing part disposed on the base, wherein the bearing part lifts a support arm of the up-down mechanism in order to facilitate the assembly of the cap and the up-down mechanism.

8. The key switch of claim 7, wherein the bearing part and the base are connected integrally.
